(19) United States
(12) Patent Application Publication
(10) Pub. No.: US 2021/0295717 A1
(43) Pub. Date: Sep. 23, 2021

(54) METHOD AND SYSTEM FOR OPTIMIZING AIRCRAFT TRAJECTORIES AND EXECUTING THEM IN THE OPERATIONAL ENVIRONMENT

(71) Applicant: University of Malta, Msida (MT)

(72) Inventors: David ZAMMIT-MANGION, Mellieha (MT); Kenneth CHIRCOP, Haz-Zebbug (MT); Alan MUSCAT, Pembroke (MT); Francis BEZZINA, Naxxar (MT); Joe DEGIORGIO, Zabbar (MT)

(73) Assignees: University of Malta, Msida (MT); Malta Air Traffic Services, Mqabba (MT); Quaero Ltd., Mosta (MT)

(21) Appl. No.: 17/209,702

(22) Filed: Mar. 23, 2021

Related U.S. Application Data
(60) Provisional application No. 62/993,311, filed on Mar. 23, 2020.

(51) Int. Cl. G08G 5/00; G05D 1/00

(52) U.S. Cl. CPC G08G 5/0039; G05D 1/0011; G08G 5/0004

(57) ABSTRACT

A method and system for accurately calculating and implementing optimized airplane flight trajectories in the operational environment that requires the involvement and cooperation of various stakeholders that provide data from different agencies that are often physically located in different geographical locations, and executing the optimized trajectories in the operational environment.

### CROSS-REFERENCE TO RELATED APPLICATIONS

This non-provisional application claims the benefit of U.S. Provisional Application No. 62/993,311, filed on Mar. 23, 2020, the entire contents of which is incorporated by reference in its entirety.

### FIELD OF THE INVENTION

The present invention relates to a method and system for determining optimized airplane flight trajectories for particular operating conditions in quasi real time and executing the optimized trajectories in the operational environment.

### BACKGROUND OF THE INVENTION

The cost of airline operations is significantly affected by the amount of fuel consumed by aircraft. Consequently airlines have an interest in trying to reduce the amount of fuel burned during flight. In addition, the reduction of fuel burn has the advantage of reducing emissions, thereby reducing the impact of aircraft operations on the environment.

Prior art and practices have attempted to address the target of reducing fuel burn during flight. For example, airlines often attempt to route aircraft through more advantageous flight paths prior to their departure. During flight, Flight Management Systems can be programmed with a particular Cost Index (CI) that balances time of flight with fuel burn and airlines can select more efficient values of the CI. Tools and methods, such as those disclosed in US 20170090182A1, U.S. Pat. Nos. 9,460,629, 9,734,724, 10,657,829 and 9,940,841 have been proposed for improving flight trajectories prior or during flight.

However, the ability to accurately calculate and implement an optimal trajectory in the operational environment requires the involvement and cooperation of various stakeholders. From a theoretical perspective, the selection of the best trajectory depends on parameters such as the specific aircraft configuration, including its weight; on the winds and weather conditions that lay ahead of the aircraft; and on the traffic constraints the aircraft will be subjected to in the air traffic environment. Many of these parameters vary during a flight and may change unexpectedly and therefore up-to-date data pertaining to these parameters needs to be sourced to enable a trajectory to be optimized. The sources of this data are from different agencies that are often physically located in different geographical locations. For example, weather data with the necessary granularity and validity (in terms of timeliness) are available from weather data service providers. Aircraft operational and intent data reside with the airline (and pilot). Air traffic constraint information is available from Air Traffic Control (ATC).

The process of obtaining and collating the necessary information from the various stakeholders to carry out an optimization of a flight trajectory, in practice, can be a challenge. One reason is because much of the data required may be proprietary in nature and/or commercially sensitive. For example, detailed weather data has commercial value and weather data service providers need to protect the service they offer. The operational data of a flight, such as an aircraft's weight and configuration is commercially sensitive. Airlines are not inclined towards freely sharing such data with other stakeholders, including ATC, and in general do not do so. Likewise, data service providers and other stakeholders are not inclined to freely share proprietary information or service they provide.

Furthermore, different stakeholders have different interests and knowledge. For example, a pilot would be aware of and interested in the safe and efficient continuation of his or her flight and not that of other flights. Likewise, a pilot would be aware of the state of his or her own aircraft and not that of others. A pilot may not be aware of the intent of other pilots flying in the vicinity. Neither will a pilot be aware of the full air traffic picture and what the air traffic controller has planned to ensure safe separation between aircraft. In comparison, whilst an air traffic controller will have a full picture of air traffic in the area being controlled, he or she would have limited knowledge on each flight. For example, the air traffic controller would not normally be aware of the aircraft configuration and operational weight. Neither would an air traffic controller be aware of other information that may be commercially sensitive to airlines such as the business case of the flight.

These limitations result in a fragmentation of the information required for accurate optimization of flight trajectories across the different stakeholders, with no one stakeholder alone currently having a full set of the required data.

Another consideration is that once an optimized trajectory is identified and validated, approval to fly it needs to be coordinated with and obtained from ATC before the pilot can execute it. Here again, different stakeholders are involved.

The process, therefore, requires the successful, timely and efficient coordination and data transfer between the various stakeholders to enable optimized trajectories to be identified and flown in normal operations.

The significance in the need for successful, timely and efficient coordination between the various stakeholders is highlighted in the context that the various relevant stakeholders have different primary interests and operational awareness. For example, pilots and airline operators focus on the efficiency of their own operations and, therefore the flights of their own aircraft. They know the operational targets and conditions of their aircraft (such as preferred time of flight; operational weight and configuration schedule of the aircraft; initial and final conditions of the segment of flight, such as altitude and speed) but need to obtain information such as wind and weather conditions from the weather data service providers. They have plans on how they wish to operate their aircraft, but they do not have a full picture of the air traffic environment and related constraints. They need approval by ATC to fly their preferred paths, but do not have the visibility of what the air traffic controller is planning to keep aircraft safely separated in the air. In contrast, ATC has the full picture of the air traffic environment and a plan of how to organise the safe routing of aircraft but does not have relevant information regarding the operating conditions of specific aircraft (such as weight and configuration); neither does it have insight into the business considerations of airlines, such as the impact of altering the flight time, or the airline's intentions (which may be affected by ATC's decisions). In addition, ATC will not have the wind and weather data in sufficient detail to enable the optimisation of a flight to be calculated with the desired accuracy.

This situation of no stakeholder having the complete picture (or data set) to enable the calculation of optimal trajectories ‘on the fly’ in quasi-real time to allow the emerging operational conditions to be taken into account and, simultaneously the authority and facility to fly these trajectories in practice provides a challenge to the successful identification and execution of optimal trajectories in practice.

This challenge can be mitigated with the timely and efficient cooperation and information transfer between the several agencies or stakeholders, such as weather data service providers, ATC, the Airline Operating Centre (AOC) and the pilot of the aircraft involved.

This timely cooperation is, currently, difficult to implement efficiently and this is partly due to the limited infrastructure, methods and practices in place to facilitate the coordination and information transfer between the different stakeholders.

A limitation, therefore, exits in the coordination and communication between different stakeholders that limits the ability for trajectories to be optimized with sufficient accuracy ‘on the fly’ in quasi real time and for these trajectories to be successfully flown in the air traffic environment.

U.S. Pat. No. 9,460,629 (incorporated herein in its entirety) discloses the need to obtain information from third parties or other agencies, but does not identify a method or process of how the necessary information and any decision-making can be exchanged between stakeholders.

The present invention attempts to mitigate some of the said limitations by disclosing a method and system for optimizing aircraft trajectories and executing them in the operational environment that includes processes the coordination and communication between different stakeholders that enable the successful execution of the optimized trajectory in the operational environment.

### SUMMARY OF THE PRESENT INVENTION

Accordingly, the present invention discloses a method, process and system that enable the gathering of the necessary data from the various stakeholders (agencies) to allow the generation of flight trajectories that are optimized according to one or a plurality of criteria (also referred to as optimization objectives) whilst taking into account up-to-date information regarding the operating conditions; and coordinate between stakeholders to allow the optimised trajectories to be flown in the operational environment.

Advantageously, the processes of gathering the necessary data from the various stakeholders and coordinating communication, including, but not limited to, that related to decision-making, between agencies facilitate the determination of the best optimal trajectories and the successful implementation of the said trajectories in the operational environment.

According to an aspect of the present invention, optimized flight trajectories are generated using an optimization algorithm or tool, such as that disclosed in U.S. Pat. No. 9,460,629 to enable fast (timely) and accurate calculations of the preferred (optimal) trajectory or trajectories.

Advantageously, the present invention provides for a process or procedure that allows exchange of information between the pilot, AOC, ATC and other agencies to enable data critical for the optimization process to be exchanged and made available to the operator who operates the optimization tool.

Advantageously, the present invention provides for a process or procedure that allows exchange of ATC clearance instructions between the pilot, AOC and ATC to enable data critical for the optimization process to be exchanged and made available to the operator who operates the optimization tool.

Advantageously, the present invention also provides for a process whereby the pilot is informed of the optimal trajectory that is cleared by ATC, thereby enabling the said optimal trajectory to be flown.

### BRIEF DESCRIPTION OF THE DRAWINGS

An exemplary embodiment of the invention will now be described with reference to the accompanying drawings, in which:

FIG. 1 presents a flowchart of an example embodiment based at an AOC;

FIG. 2 presents a flowchart of an example embodiment based within ATC;

FIG. 3 presents a flowchart of an example embodiment operated by the pilot of an aircraft;

FIG. 4 illustrates a block diagram of an embodiment of the system; and

FIG. 5 shows an example embodiment of the computing device in which the optimization tool in FIG. 4 may be installed and executed.

### DETAILED DESCRIPTION OF PREFERRED EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

It is understood that steps in the disclosed flow charts may vary due to, for example, but not limited to, operating procedures; may be automated or skipped. It is also understood that the sequence of steps may be changed.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures unless otherwise indicated. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as circuits, program modules or functional processes include routines, programs, objects, components, data structures, etc., that perform particular tasks or implement particular abstract data types and may be implemented using existing hardware. The operations be implemented using existing hardware in existing electronic systems (e.g., display drivers, System-on-Chip (SoC) devices, SoC systems, electronic devices, such as personal digital assistants (PDAs), smartphones, tablet personal computers (PCs), laptop computers, etc.). Such existing hardware may include one or more Central Processing Units (CPUs), digital signal processors (DSPs), application-specific-integrated-circuits (ASICs), SoCs, field programmable gate arrays (FPGAs), computers, or the like, configured as special purpose machines to perform the functions described herein as well as any other well-known functions of these elements. In at least some cases, CPUs, SoCs, DSPs, ASICs and FPGAs may generally be referred to as processing circuits, processors and/or microprocessors.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “memory,” “memory unit,” “storage medium,” “computer readable storage medium,” and the like, may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

In an example embodiment, the flight trajectory optimization tool (hereinafter “the tool”) on which the optimization of the flight trajectory or trajectories are calculated is located within Air Traffic Control (ATC).

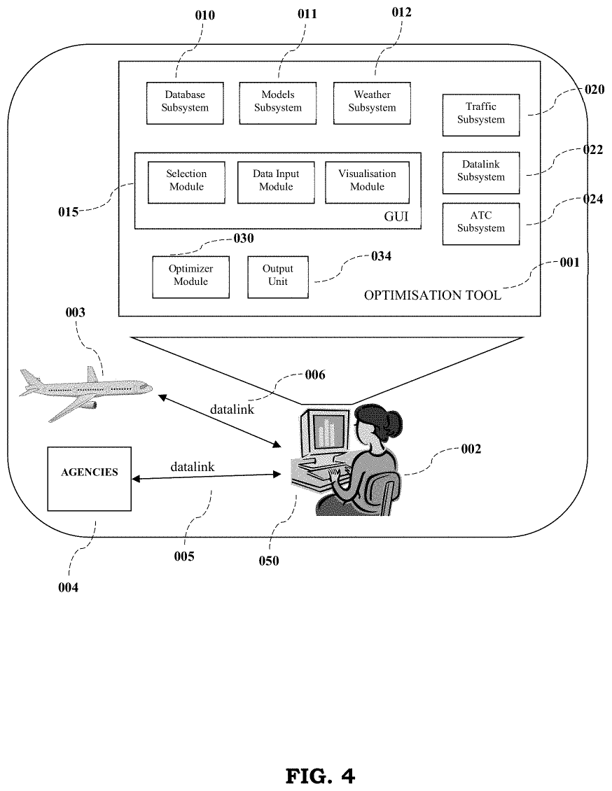

As shown in FIG. 4, the tool 001 contains various sub-systems, such as the optimizer module 030 that conducts the mathematical optimization process; a models subsystem 011 that contains details on the specific aircraft relevant to the optimization; and a Graphical User Interface (GUI) 015. The tool 001 resides within a computer system 050 that is connected by datalinks 005 to other agencies 004, such as a weather data service provider or an AOC. The computer system 050 may also be connected via a datalink 006 to the aircraft 003 to allow coordination with the pilot. It is understood that the said datalinks may take any of various forms, such as those typically used by industry, and may include, but are not limited to, normal telephony, the Aeronautical Fixed Telecommunication Network (AFTN), ACARS or VHF radio as well as other datalinks such as, but not limited to, Ethernet and RS-232. It is understood that the operation of several of these datalinks may involve voice communication and that data may be exchanged by voice.

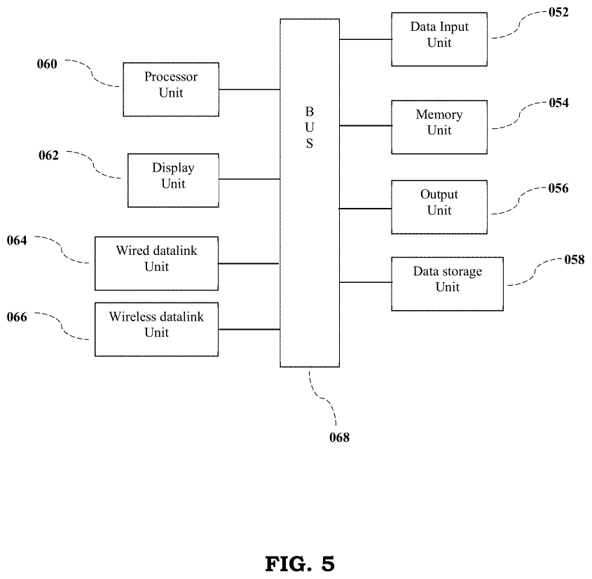

As shown in FIG. 5, the computer system 050 includes a processor unit 060, a memory unit 054, a data storage unit 058, a display unit 062 and a data input unit 052 connected by a bus 068. The bus 068 enables communication and transfer of data between the various units of the computer system 050. The computer system 050 also has other units connected to the bus 068, such as a wired datalink unit 064 and wireless datalink unit 066 that connect the datalinks 005 with other agencies 004 and datalinks 006 with other aircraft 003. The data storage unit 058 may store information such as the optimization programme and relevant data, including databases, when the computer is switched off and when the memory is full. The data input unit 052 may include input devices normally available on computer systems, such as, but not limited to, a keyboard, mouse, tracker ball and touch screen. The display unit 062 may be, but is not limited to, a device such as a Liquid Crystal Display screen. The wired and wireless datalink units 064 and 066 provide interface for input and output of data via wired/wireless transmission media and include the necessary hardware and software to provide the link. The wireless datalink unit 066 may involve transceivers such as, but not limited to, microwave, RF and infra-red.

The data output unit 052 can output data in digital format to other systems and sub-systems external to the computer system 050, including other agencies 004, via the datalink units 064 and 066.

The processor unit 060 may be, for example, a microprocessor capable of executing instructions included in computer readable code. The term ‘processor’, as used herein, may refer to, for example, a hardware-implemented data processing device having circuitry that is physically structured to execute desired operations including, for example, operations represented as code and/or instructions included in a program. Examples of the above-referenced hardware-implemented data processing device include, but are not limited to, a microprocessor, a central processing unit (CPU), a processor core, a multi-core processor; a multiprocessor, an application-specific integrated circuit (ASIC), and a field programmable gate array (FPGA).

The memory unit 054 may be any device capable of storing data including magnetic storage, flash storage, or similar, including for example, RAM, ROM, Flash memory, hard disk, or other known storage device. The display unit 062 may be any device capable of displaying data including, for example, a computer monitor, a tablet or personal device display, or similar. The display 062 may also include a touch screen capable of receiving user input commands, which touch screen may form part of the data input unit 052.

It is understood that all the units within the computer system 050 include all necessary devices and sub-systems necessary for the disclosed functions.

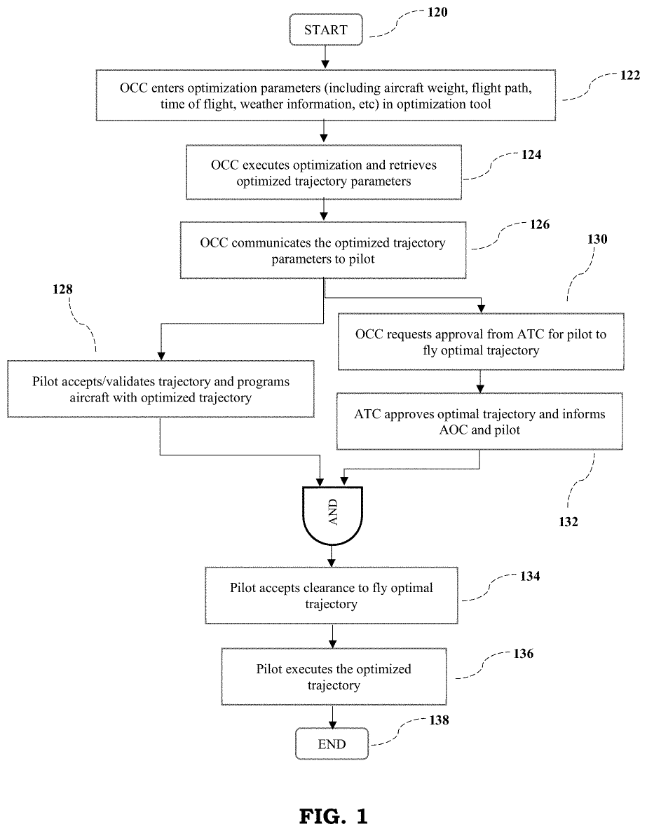

The various functions performed by the computer system 050 may be in the form of computer code stored in a tangible non-transitory computer readable medium including, for example, an optical disc, flash drive, HDD, or other known types of such computer readable media. The computer code includes instructions capable of causing a computer to perform operations associated with the computer system 050 in the various steps of FIGS. 1, 2, and 3.

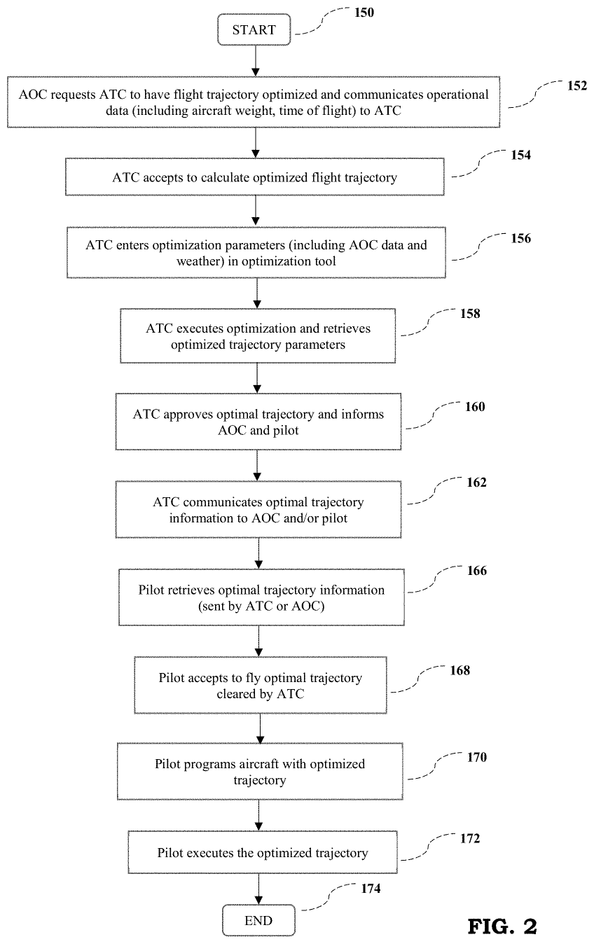

According to an example embodiment, the optimization is performed by the operator 002 on the computer system 050 within ATC. A typical method or process for the optimization to be carried out and, eventually executed by the pilot or relevant aircraft is presented in FIG. 2.

In accordance with FIG. 2, the process is started (Step 150) with the AOC (also known as the Operational Control Centre OCC) requesting ATC to perform an optimization calculation for a particular flight or flights (Step 152). In the process the AOC/OCC communicates, via one of the datalinks 005 (which may also be done verbally via telephone or radio) the operational data of the aircraft/flight or flights or relevance. This data may include, but is not limited to, parameters such as aircraft weight or time of flight.

It is understood that any of the steps of AOC/OCC can be carried out by the pilot. For example, it may be preferred that the pilot, on behalf of the operator or airline, requests ATC to perform an optimization of the flight trajectory. This may be done verbally via radio normally used for communications between pilots and ATC, but it is understood that the communication medium between the pilot and ATC can be any link that may be used between the two. Today, a digital datalink, CPDLC, is also used as a communication link between the pilot and ATC.

Also, since the pilot will have direct access to certain parameters such as aircraft flying altitude and weight and up-to-date intent in flight, and also normally communicates with ATC during a flight, it is understood that the pilot may communicate directly with ATC parameters that are relevant to the optimization.

On receiving the request ATC accepts (or otherwise) to calculate the relevant optimal flight trajectory or trajectories (Step 154). In view that certain optimization tools, such as that disclosed in U.S. Pat. No. 9,460,629, can optimize the trajectories of several aircraft simultaneously, it is understood that the process described in FIG. 2 may include requests for ATC to calculate the optimal trajectories of multiple aircraft simultaneously. It is also understood that ATC may integrate the requests of pilots or AOC/OCCs of multiple airlines, whereby ATC may determine the overall optimized trajectories of multiple aircraft and, possibly, of different operators. Furthermore, it is understood that ATC may reject to calculate optimal flight trajectories due to operational reasons, such as weather, traffic and operational facilities and resources available at the time.

ATC may communicate the acceptance (or otherwise) to calculate the optimized trajectory or trajectories to the pilot or the relevant AOC/OCC via one of the datalinks 005 and 006.

The operator 002 enters the relevant parameters in the optimization tool 001 (Step 156) and then executes (Step 158) the optimization using the optimization tool 001 on the computer system 50. It is understood that the optimization may require information such as wind and weather data that may be obtained from other agencies 004 via the datalink 005, as, for example, disclosed in U.S. Pat. No. 9,460,629. It is also understood that the entering of relevant parameters (Step 156) may be done automatically by the computer system 050, which can receive the relevant data via datalinks 005 and 006. The execution of the optimization (Step 158) allows the retrieval (Step 158) of relevant parameters that define the optimized trajectory for onward communication (Step 162) to the AOC/OCC or pilot.

Once the optimized trajectory or trajectories for the relevant (single or multiple) aircraft are generated, ATC accepts (approves) them (Step 160) and communicates its decision (Step 162), together with data pertaining to or defining the optimized trajectories, such as speed schedules, to the pilot and/or AOC/OCC as relevant. In the event ATC communicates with the airline AOC/OCC (such as, for example, via datalink 005 that may, but is not limited to, use an existing datalink such as AFTN), the AOC/OCC may then relay relevant information to the pilot. This communication between the AOC/OCC and the pilot may be, but is not limited to being, conducted via an existing datalink such as ACARS. Alternatively, voice radio may be used.

On receiving the optimal trajectory information (Step 166), the pilot accepts (Step 168) to fly the optimized trajectory that will have been generated (and therefore cleared) by ATC or otherwise and may inform ATC accordingly.

On accepting to fly the optimized trajectory, the pilot may then program (Step 170) the aircraft or its systems to fly it. It is understood that, in current practice, the aircraft systems include the Flight Management System and Autopilot. The pilot will then execute (Step 172) the optimized trajectory and the process ends (Step 174).

In another example embodiment, the optimization of the flight trajectory or trajectories is carried out using the optimization tool 001 installed on the computer system 050 within the airline, typically within the AOC/OCC.

As shown in FIG. 4, the operator 002 operates the computer system 050 that communicates with other agencies, such as those providing weather data, and ATC via datalink 005.

In a preferred embodiment, the AOC/OCC coordinates with ATC to obtain clearance (approval) for the optimized trajectory to be flown and then the approved flight trajectory is communicated to the pilot via the wireless datalink 006. It is understood that, as for the first example embodiment, the flight trajectory may be defined by, but not limited to, speed schedules, for example, during climb and descent.

As shown in FIG. 1, the process in the AOC/OCC is started (Step 120) and the operator 002 enters the relevant operational parameters in the optimization tool 001 via the data input unit 052 of the computer system 050 (Step 122). The operator 002 then executes (Step 124) the optimization. The optimization tool 001 may retrieve data relevant to the optimization process, such as, for example that relating to weather and ATC constraints as disclosed in U.S. Pat. No. 9,460,629, from other agencies 004 via datalink 005.

Once the optimization process is completed by the optimization tool 001, the operator 002 retrieves (Step 124) the optimized trajectory (typically in the format of parameters that define the trajectory). The AOC/OCC may communicate (Step 126) the optimized trajectory or its parameters to the pilot, who can then accept or decline the proposed trajectory (Step 128), prior to its formal approval by ATC.

The AOC/OCC also communicates the optimized trajectory to ATC and requests (Step 130) its approval by ATC to allow the pilot to fly the optimized trajectory. This communication may occur via datalink 005. It is understood that this step may be conducted by the pilot instead of the AOC/OCC.

ATC considers the request to approve the optimized trajectory and, if approved, informs (Step 132) the AOC/OCC and/or the pilot, as appropriate. This communication may occur via datalink 005 and existent wireless voice or data links between ATC and the aircraft 003.

Having already validated the optimal trajectory, the pilot may accept to fly it (Step 134) and programs the appropriate aircraft systems to execute it (Step 136). The process then ends (Step 138).

In another example embodiment, the optimization of the flight trajectory is carried out using the optimization tool 001 installed on a computer system 050 on the aircraft 003. It is understood that the computer system may be installed in the aircraft 003 or may be portable, such as a laptop, tablet, etc. It is also contemplated herein that the optimization tool 001 may be integrated in a FMS and furthermore may be linked with the automatic guidance system of the aircraft.

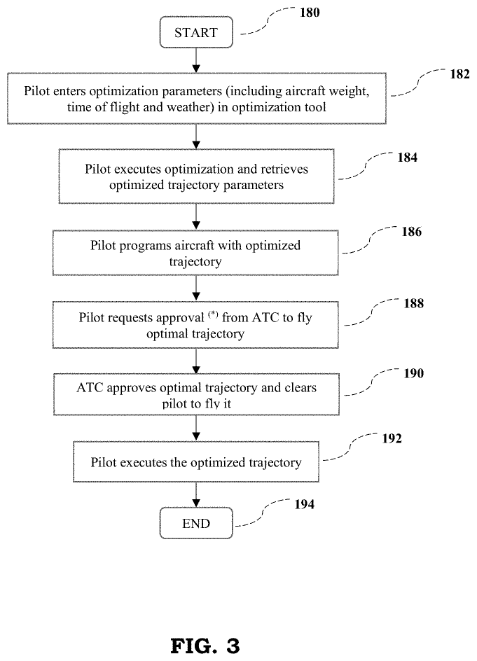

As shown in FIG. 3, in this embodiment, the pilot starts (Step 180) the process and, acting as the operator 002 enters (Step 182) the optimisation parameters in the optimisation tool 001 installed on the computer system 050. It is understood that, with respect to FIG. 4, the operator 002 and computer system 050 are on the aircraft and the aircraft 003 in the figure represents other aircraft that the pilot may need to communicate with. Certain data, such as that pertaining to weather, winds and ATC clearances may be automatically transferred to the computer system 050 from the relevant agencies 004 via appropriate datalinks 005.

The pilot then executes the optimization process by running the optimisation tool 001 and retrieves the optimized trajectory parameters (Step 184). The pilot may then, if appropriate or necessary, program (Step 186) the appropriate aircraft systems, such as the Flight Management System or Autopilot, in preparation to fly the optimized trajectory. It is understood that the step of retrieving the data (Step 184) and programming (Step 186) the aircraft systems may be automated by, for example linking the computer system 050 with the relevant aircraft systems such as the FMS or autopilot.

The pilot communicates with ATC and requests approval (Step 188) from ATC to fly the optimal trajectory. This communication is performed via datalink 005, which may take the form of existing communication links between the pilot and ATC such as voice radio or digital datalinks such as, but not limited to, CPDLC.

If ATC approves (Step 190) the proposed optimal trajectory, the pilot then executes it (Step 192). It is understood that this step may involve the pilot instructing the relevant aircraft systems to execute the optimized trajectory. The process ends at Step 194.

1. A method of selecting a trajectory for an aircraft and flying the said trajectory, including the steps of:
obtaining parameters pertaining to the trajectory and operation of the aircraft;
entering the parameters in an optimisation software tool;
determining, via the optimisation software tool, a preferred trajectory; and
flying the preferred trajectory.

2. The method of claim 1, wherein the steps of entering the parameters in an optimisation software tool and determining a preferred trajectory is carried out by air traffic control and
the step of obtaining parameters pertaining to the trajectory and operation of the aircraft includes communicating with other agencies to obtain the parameters, and
the preferred trajectory is communicated to the aircraft for the execution of the step of flying the preferred trajectory.

3. The method of claim 1, wherein the steps of entering the parameters in an optimisation software tool and determining a preferred trajectory is carried out on the ground by the operator of the aircraft and
the step of obtaining parameters pertaining to the trajectory and operation of the aircraft includes communicating with other agencies to obtain the parameters, and
the preferred trajectory is communicated to the aircraft for the execution of the step of flying the preferred trajectory.

4. The method of claim 1, wherein the steps of entering the parameters in an optimisation software tool and determining a preferred trajectory is carried out by the pilot of the aircraft and
the preferred trajectory is communicated air traffic control prior to the execution of the step of flying the preferred trajectory.

5. A system for generating a trajectory of an aircraft, including
means for communication between agencies and an aircraft, and
means for generating a preferred trajectory of an aircraft.
